(19) United States
(12) Patent Application Publication
(10) Pub. No.: US 2012/0312120 A1
(43) Pub. Date: Dec. 13, 2012

(54) VENTING ASSEMBLY

(75) Inventors: Michael Engelmann, St. Augustin (DE); Ralf Schäfer, Koln (DE); Kurt Müller, Merzenich (DE)

(73) Assignee: GKN DRIVELINE INTERNATIONAL GMBH, Lohmar (DE)

(21) Appl. No.: 13/511,634

(22) PCT Filed: Nov. 23, 2009
(86) PCT No.: PCT/EP2009/008314

§ 371 Date: Aug. 27, 2012

(51) Int. Cl. F16H 57/04

(52) U.S. Cl. 74/606 A

(57) ABSTRACT

The disclosure relates to a venting assembly for a unit with components running in a lubricant. The venting assembly comprises a housing part, a rotating component which, by a rolling contact bearing, is rotatably supported around an axis of rotation relative to the housing part, as well as a venting channel for venting the assembly, wherein an inner opening of the venting channel is arranged so as to axially adjoin the rolling contact bearing, and wherein, in an axial view, the opening of the venting channel at least partially covers the rolling contact bearing. Furthermore, the disclosure relates to a transmission assembly with such a venting assembly.

### TECHNICAL FIELD

The disclosure relates to a venting assembly for a unit with components which run in a lubricant and which are rotatably supported by a rolling contact bearing, and in one particular exemplary embodiment, for a transmission in the driveline of a motor vehicle. Such venting assemblies serve to be able to release an increased internal pressure of said unit into the atmosphere, while at the same time the lubricant is prevented from running out and foreign matter is prevented from entering the unit.

### BACKGROUND

From DE 199 45 897 A1 a transmission venting assembly is known for a transfer case. The transfer case includes a housing in which an input shaft is rotatably supported by a bearing. In the axial vicinity of the bearing there is arranged a seal which seals the annular chamber between the input shaft and the housing. Between the bearing and the seal a venting chamber is provided whose purpose it is to reduce the pressure in the transfer case.

In general it is difficult to design and arrange a suitable transmission venting system because of the prevailing installation conditions, more particularly in view of the general requirement to provide a compact and lightweight construction for structural units in the driveline of a motor vehicle.

### SUMMARY

A venting assembly is disclosed for a unit with components which run in a lubricant and which are rotatably supported by one or several rolling contact bearings, more particularly in the driveline of a motor vehicle. The assembly requires a small amount of space, permits good venting conditions, thereby preventing lubricant from entering the interior of the transmission and comprises a simple design. A transmission assembly with such a venting assembly is also described herein.

A venting assembly for a unit with components running in a lubricant, comprises a housing part; a rotating component which is at least indirectly rotatably supported relative to the housing part by a rolling contact bearing around an axis of rotation; and a venting channel for venting the unit. An inner opening of the venting channel is arranged so as to axially adjoin the rolling contact bearing. In an axial view, the opening of the venting channel at least partially overlaps the rolling contact bearing.

An exemplary advantage of the venting assembly disclosed herein is that the rolling contact bearing of the rotating component may be used for generating a pumping effect for conveying the lubricant. Operating the structural unit, which comprises components rotating in lubricant, especially at high speeds, could result in the formation of foam and the rise of the lubricant in the venting channel. Because the opening of the venting channel is positioned in the region of overlap with the rolling contact bearing, the rotation of the rolling contact bearing causes lubricant being conveyed out of the region of the opening downwards and into the interior of the unit. In this way, lubricant is prevented from moving outwardly from the interior of said unit, such outward movement of the lubricant would be undesirable. A further effect consists in that as a result of the rotating parts of the rolling contact bearing, the lubricant contained in the venting channel experiences a swirl which leads to a reduction in the formation of foam of the lubricant in this region. Furthermore, the venting assembly described herein prevents the escape of lubricant, even under extreme operational conditions of the unit.

It shall be understood that the rolling contact bearing can have any design to meet the requirements for the supporting conditions of the rotating part. A groove ball bearing or an angular contact ball bearing is particularly suitable, but other types of bearing such as a taper roller bearing are not excluded. The rotating component can be a driveshaft or a shaft journal in a transmission, for example. The lubricant can be any lubricant which is suitable for cooling and lubricating the rotating parts, such as oil.

The partial overlap of the opening with the rolling contact bearing in accordance with this disclosure, means that the rolling contact bearing, in an axial view, defines an imaginary annular face and that the opening, in an axial view, defines an imaginary opening face, with the opening face and the annular face, in an axial view, together form a sectional face which can also be referred to a face of overlap.

“Inner opening” means that the opening faces the interior of the unit, whereas the opposed outer opening of the venting channel opens into the environment. The venting channel thus connects the interior of the unit to the environment. Thus, any excess pressure developing during operation in the unit as a result of heat can escape through the outer opening of the venting channel into the environment. Vice versa, when the unit stops operating and cools down as a result, air can flow from the environment into the interior of the assembly.

According to one exemplary arrangement, the housing part comprises at least one portion which, in the mounted condition, forms a side wall of the unit, as a result of which there is achieved a simple and compact design of the venting assembly. In one exemplary arrangement, the housing part with the venting channel is at least partially formed onto a housing of the unit, and may be integral with the housing, which, again, results in a simple and compact design of the venting assembly.

The rotating component, in a region adjoining the rolling contact bearing, comprises an end face which is arranged opposite a wall portion of the housing part. The end face of the rotating component is meant to be the face which is positioned in the vicinity of the rolling compact bearing. To achieve a compact design and satisfactory lubricant conveying conditions, it is advantageous if, between the end face of the rotating component and the housing part, there is formed as small an axial gap as possible, with the axial width of the gap, in some exemplary arrangements, preferably being smaller than the axial width of the rolling contact bearing, more particularly smaller than half the axial width of the rolling contact bearing.

In one exemplary arrangement, the annular portion of the rolling contact, which annular portion does not overlap with the opening, the rolling contact bearing is arranged so as to immediately axially adjoin the wall portion of the housing part. This means, in the region of overlap between the opening and the rolling contact bearing, there is formed a certain opening chamber, whereas in the remaining annular portion of the rolling contact bearing, there is formed only a small axial gap relative to the wall portion. To ensure satisfactory conveying conditions for the lubricant it is proposed that the axial extension of the opening chamber is greater than the axial gap between the remaining annular portion of the rolling contact bearing and the housing wall.

According to one exemplary arrangement, the opening of the venting channel is positioned at least partially between the greatest outer diameter of the rolling contact bearing and the smallest inner diameter of the rolling contact bearing. In this way, there is achieved a particularly good pumping effect as a result of the rotational movement of the rolling contact bearing and the suction action out of the opening region of the venting channel. It is particularly advantageous if the entire inner opening of the venting channel is positioned in the radial region between the greatest outer diameter of the rolling contact bearing and the smallest inner diameter of the rolling contact bearing.

According to another exemplary arrangement, it is proposed that the rolling contact bearing comprises a first central plane comprising the axis of rotation and that the inner opening comprises a second central plane, wherein the second central plane is arranged offset relative to the first central plane of the rolling contact bearing. The offset is configured such that in the preferential direction of rotation of the rolling contact bearing, the pumping effect is increased. In another arrangement, in an axial view of the rolling contact bearing, the inner opening of the venting channel is arranged at least partially in a region in which the rolling contact members of the rolling contact bearing comprise a vertically downwards extending movement component in the preferential direction of rotation. In this way, the rolling contact members of the rolling contact bearing, when rotating, convey lubricant from the opening chamber downwards into the interior of the unit.

According another exemplary arrangement, the venting assembly comprises a plug device which closes the upper opening of the venting channel. The plug device may comprise a labyrinth seal which allows the passage of air. Furthermore, in other exemplary arrangements, the plug device comprises an insertable part with a base, which insertable part is positioned at least partially in the venting channel, wherein the insertable part comprises at least one lateral aperture to allow the passage of air. The base of the insertable part forms a barrier for any lubricant which escapes upwards during operational conditions. To prevent any dirt or other particles from entering through the venting channel into the unit, the plug device comprises a removable cap which can be releasably connected to the insertable part, more particularly by a snap-in connection or a threadable connection. There is also possibility of using the venting channel for filling the unit with lubricant. For this purpose, the cap has to be removed from the insertable part. The venting channel and the remaining cross-sections of the venting assembly are designed such as to ensure sufficiently large through-flow quantities to keep the filling time for the assembly as short as possible.

Furthermore, a unit may be provided in the form of a transmission assembly, more particularly for being used in the driveline of a motor vehicle, comprising a transmission housing which encloses an inner chamber and in which at least two driveshafts are drivingly connected to one another for transmission of torque, wherein the venting assembly is provided in accordance with one of the above-mentioned embodiments. The housing part of the venting assembly forms part of the transmission housing; wherein the rotating component is one of the at least two driveshafts; wherein the venting channel serves to vent the inner chamber.

Said transmission assembly has the above-mentioned advantages of preventing lubricant from escaping from the interior of the housing while at the same time featuring a compact design. The pumping effect of the rolling contact bearing of the driveshaft is used—under rotational conditions—for conveying lubricant from the region of the opening downwards and into the interior of the transmission housing. In this way, lubricant is prevented from undesirably escaping downwards out of the interior of the transmission. More particularly, also under extreme operational conditions of the transmission assembly such as they can occur under conditions of longitudinal and transverse acceleration, for instance in connection with inclination tests, the inventive transmission assembly effectively prevents the escape of lubricant. A further aspect is that the lubricant contained in the venting channel experiences a swirl as a result of the rotating part of the rolling contact bearing, which swirl reduces the formation of lubricant foam in the region of the opening.

The transmission assembly may be provided in the form of a multi-step transmission, more particularly a two-step cylindrical gear transmission for a hybrid drive. The multi-step transmission is driven by an electric motor and transmits torque via a differential gear arranged in the torque flow to the righthand and lefthand sideshaft of a motor vehicle. However, it is to be understood that the venting assembly can also be used in any other structural unit or transmission assembly in which rotating parts are supported by rolling contact bearings. The venting assembly is particularly suitable for units in which the rotating parts rotate at particularly high speeds where the likelihood of foam formation is particularly high. In such cases, the inventive venting assembly effectively reduces such foam formation, so that, in the final analysis, the escape of lubricant out of the unit housing is prevented.

Exemplary embodiments of the invention will be described below with reference to drawings wherein

### BRIEF DESCRIPTION OF THE DRAWINGS

FIG. 1 is a longitudinal section through a venting assembly in a first embodiment.

FIG. 2 is a cross-sectional view of the venting assembly according to FIG. 1.

FIG. 3 is a longitudinal section of a venting assembly in a second embodiment.

FIG. 4 is a cross-sectional view of the venting assembly according to FIG. 3.

FIG. 5 is a sectional view through the rolling bearing of the venting assembly according to FIG. 3 in the form of a detail.

FIG. 6 shows a housing part of the venting assembly according to FIG. 1 in a housing of a transmission assembly in a slightly perspective view of the transmission assembly from the outside.

FIG. 7 shows the transmission assembly according to FIG. 6 in a longitudinal section through the venting assembly.

FIG. 8 shows the transmission assembly according to FIG. 6 in a cross-sectional view through the venting assembly, seen from the inside.

FIG. 9 shows the transmission assembly according to FIG. 6 in a horizontal section through the venting assembly.

### DETAILED DESCRIPTION

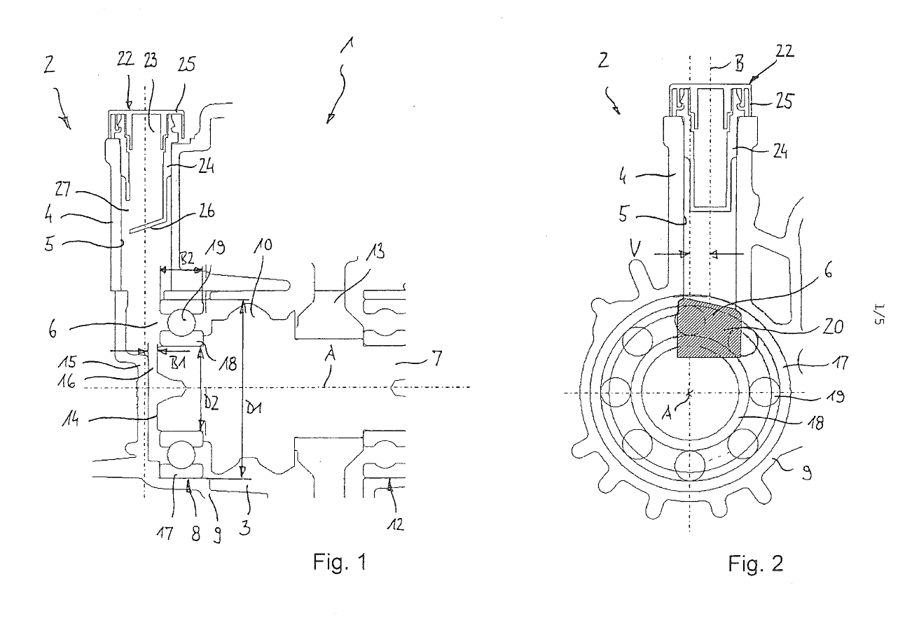

FIGS. 1 and 2 will be described jointly below. They show a venting assembly 2 for a unit 1, which is only partially illustrated. The venting assembly 2 serves to release an increased internal pressure into the atmosphere, which internal pressure is generated when the unit 1 is operated, while at the same time it is intended to prevent any lubricant from escaping and any foreign substances from entering the interior of the unit 1.

The venting assembly 2 comprises a housing part 4 in which there is formed a venting channel 5 which, via an opening 6, is connected to the interior 3 of the unit 1. Furthermore, the venting assembly comprise a rotating component 7 with a longitudinal axis A which is rotatably supported by a first rolling contact bearing 8 and a second rolling contact bearing 12 in a housing 9 of the transmission unit 1.

The unit 1 is provided in the form of a transmission assembly, wherein the rotating component 7 constitutes a shaft of the transmission assembly. A helical gear 10 which engages a further gear (not shown) is firmly connected to the shaft 7. At the opposite end of the shaft 7 there is provided the second rolling contact bearing 12 by which the shaft 7 is rotatably supported in the housing 9. Furthermore, it is possible to see the hub 13 of a further gear which comprises a greater diameter than the first gear 10 and which is arranged between the first gear 10 and the second rolling contact bearing 12. The second gear (13), serving for torque transmission, engages another gear which, for example, can be arranged on a shaft (not illustrated) extending parallel to the shaft 7.

It can be seen that the end face 14 of the shaft 7, which end face 14 adjoins the rolling contact bearing 8, is arranged opposite a housing portion 15 of the housing 9. Between the end face 14 and the housing portion 15 there is formed an axial gap 16 whose width is smaller than the axial width and the radial extension of the rolling contact bearing 8. Above the gap 16, the opening chamber 6 is formed, and it can be seen that the axial width of the opening chamber 6 which is formed between the rolling contact bearing 8 and the housing part 4 is greater than the gap 16. The housing part 4 which forms the venting channel 5 is firmly connected to the housing 9, more particularly it is produced so as to be integral therewith. During the casting process, the venting channel 5 can be formed on to the housing 9.

The rolling contact bearing 8 comprises an outer bearing race 17 received in a corresponding cylindrical bearing portion 21 of the housing 9; an inner bearing race slid on to a corresponding cylindrical portion of the shaft 7; and a plurality of balls 19 running in corresponding grooves of the outer bearing race 17 and of the inner bearing race 18. In the present embodiment, the rolling contact bearing 8 is provided in the form of a deep groove ball bearing, but it is to be understood that other types of rolling contact bearing can also be used, for instance an angular contact ball bearing or a tapered roller bearing.

It can be seen that the opening 6 of the venting channel 5 radially overlaps with the contact roller bearing 8, which means that the opening chamber of the venting channel 5 and the interior 3 form a sectional face 20 which at least partially is positioned in the region of the rolling contact bearing 8. By arranging the opening 6 in the region of overlap with the rolling contact bearing 8, upon rotation of the rolling contact bearing 8, lubricant is conveyed from the opening chamber 6 downwards and into the interior 3 of the transmission assembly 1. In FIG. 2, the sectional face 20 between the opening 6 and the annular face of the rolling contact bearing 8 is hatched. The shape of the sectional face 20 is formed as an overlapping of the annular chamber, which is formed by the rolling contact bearing 8, with the venting channel 5. To achieve a particularly good pumping effect, it is advantageous, as in the present case, for the entire inner opening 6 of the venting channel 5 to be positioned in the radial region between the greatest outer diameter D1 of the rolling contact bearing and the smallest inner diameter D2 of the rolling contact bearing 8.

In FIG. 2 it can be seen that the venting channel 5, with its longitudinal axis B, is laterally offset relative to the axis of rotation A of the rolling contact bearing 8, i.e. the longitudinal axis B intersects the axis of rotation A at a distance. Said offset V is such that in the preferential direction of rotation of the rolling contact bearing 8 the pumping effect is increased. In an axial view of the rolling contact bearing 8, the inner opening 6 of the venting channel 5 is arranged at least partly in a region in which the rolling members 19 of the rolling contact bearing 8 in the preferential direction of rotation of the rolling contact bearing 8 comprise a movement component extending vertically downwards. In this way, the rolling members 19 of the rolling contact bearing 8, when rotating, convey lubricant from the opening chamber 6 downwards into the interior 3 of the transmission assembly 1.

Furthermore, the venting assembly 2 comprises a plug 22 which closes the upper opening 23 of the venting channel 5. The plug 22 is provided in two parts and comprises an insertable part 24 which is inserted into the venting channel 5 and a cap 25 which is releasably connected to the insertable part 24. Between the insertable part 24 and the cap 25 there is formed a labyrinth seal which prevents dirt or other particles from reaching the interior 3 through the venting channel 5. The connection between the insertable part 24 and the cap 25 is effected by a snap-in connection, with other releasable types of connection not being excluded. The insertable part 24 comprises a lower base 26, with an aperture 27 being formed in the casing portion of the insertable part 24. In an advantageous way, the removable cap 25 of the venting assembly 2 permits the venting channel 5 also being used for filling the assembly with a lubricant. For this purpose, the cap 25 merely has to be removed from the insertable part. More particularly, it is proposed that the venting channel 5 and the remaining cross-sections of the venting assembly 2 are designed such that sufficiently large through-flow quantities can be achieved in order to reduce the filling time for the transmission assembly.

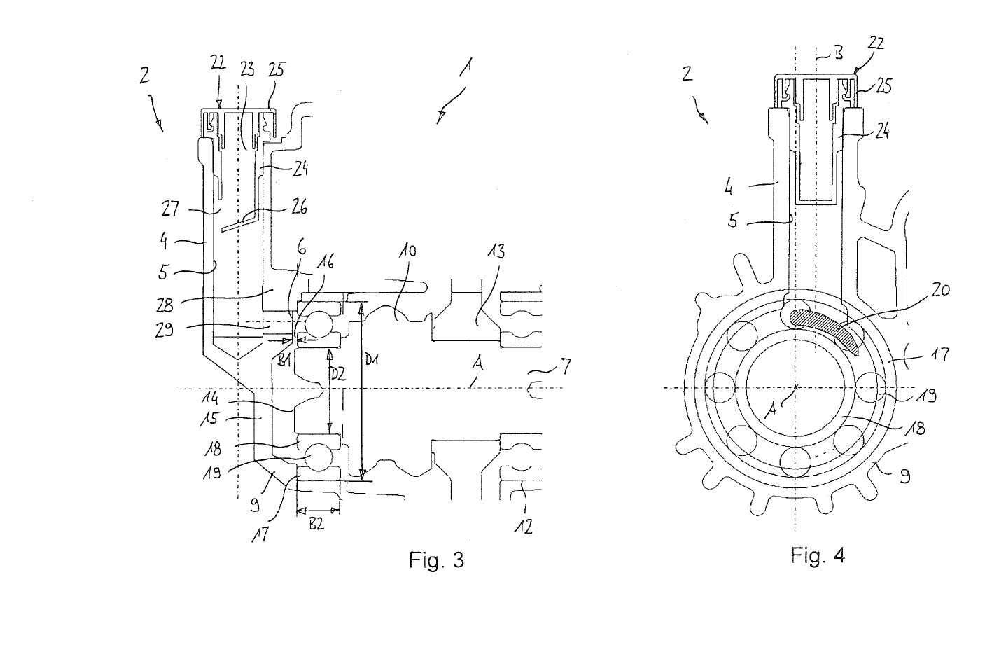

FIGS. 3 to 5, which will be described jointly below, show an inventive venting assembly 2 in a further embodiment which largely corresponds to the embodiment according to FIGS. 1 and 2, so that, as far as common characteristics are concerned, reference is made to the above description. Identical or modified components have been given the same reference numbers. Below, mainly the differences of the present embodiment relative to the previous embodiment are described.

A difference of the present embodiment refers to the design of the opening 6 of the venting channel 5 in the interior 3. It is particularly obvious in FIG. 3 that the venting channel 5 has been provided in the form of a bore in the housing part 4. In the axial region between the rolling contact bearing 8 and the venting channel 5 there is provided an intermediate wall 28 in which there is formed a through-aperture 29 which connects the venting channel 5 to the interior 3. With reference to the radial extension of the rolling contact bearing 8, the through-aperture 29 is arranged between a greatest outer diameter D1 of the outer bearing race and a smallest inner diameter D2 of the inner bearing race. In this way, upon rotation of the shaft 7, it is particularly easy for the rolling contact bearing 8—due to the pumping effect of the rolling contact members 19—to convey lubricant from the venting channel 5 into the interior 3. During the casting process for example, the through-aperture can be formed by a suitable core to be inserted into the die.

FIG. 4 shows the sectional face 20 between the opening chamber 6 and the interior 3 in the region of the rolling contact bearing 8. It can be seen that the sectional face 20 extends approximately sickle-like in an annular portion of the rolling contact bearing 8. In the present embodiment, too, the opening 6 and, respectively, the longitudinal axis B of the venting channel 5 are laterally offset relative to the axis of rotation A. In this way, it is ensured that, in the preferential direction of rotation of the rolling contact baring 8, the rolling contact members 19 comprise a downward extending movement component. Thus, when the rolling contact bearing 8 rotates, lubricant is conveyed from the opening chamber 6 away in the direction of rotation of the rolling contact bearing 8 into the interior 3 of the transmission assembly.

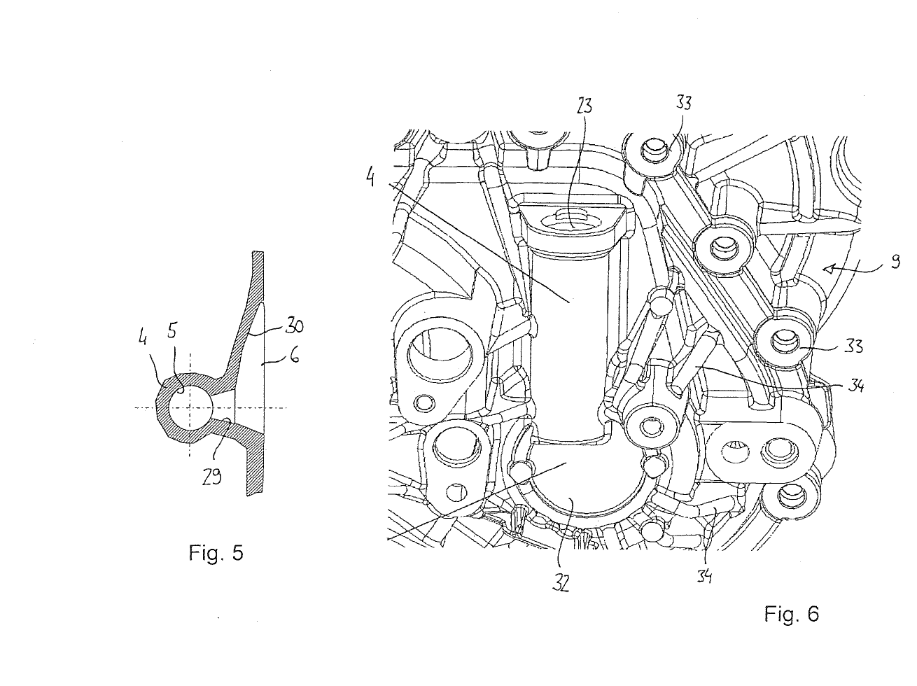

As is particularly obvious from FIG. 5, the through-aperture 29 is followed by a transition region 30 which extends in the circumferential direction of the rolling contact bearing 8 along an annular portion. The transition region 30 and the through-aperture 29 comprise conical side walls, so that a suitable casting core can be inserted from the inside and removed after the completion of the casting process.

Between the intermediate wall 28 and the rolling contact bearing 8 there is provided an axial gap whose width B1 is relatively small in order to achieve a satisfactory pumping effect. Said gap is smaller than the axial width B2 of the rolling contact bearing 8, preferably even smaller than half, or a quarter of, the axial width B2 of the rolling contact bearing 8.

FIGS. 6 to 9 show further details regarding the shape and design of the venting assembly 2 and of the housing 9 of the transmission assembly 1, wherein however only the housing 9 is shown, i.e. the remaining components such as the rolling contact bearing and the shaft are not shown in these Figures.

FIG. 6 shows the housing part 4 of the housing 9 which comprises a cylindrical shape. The cylindrical housing part 4 in which there is formed the venting channel 5 extends downwards, preferably in a vertical direction, as far as the bearing cover 32 behind which the shaft and the rolling contact bearing being arranged. There are also shown various threaded holes 33 for fixing a further housing part, as well as reinforcing ribs 34 of the housing 9.

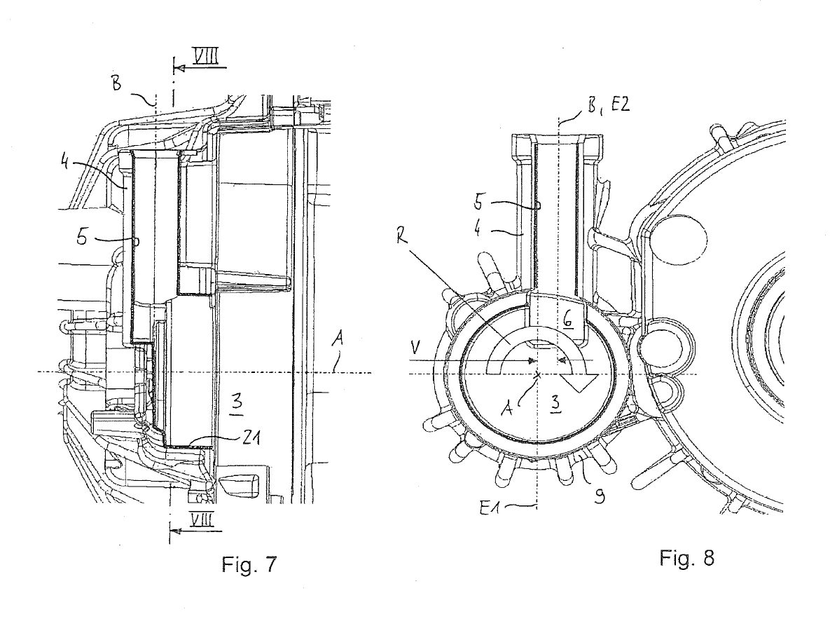

The drawing in FIG. 7 largely corresponds to that shown in FIG. 1, but only the housing 9 is shown. Figure particularly clearly shows the overlap of the venting channel 5 with the interior 3 in the region of the cylindrical bearing portion 21 for the rolling contact bearing. The cylindrical bearing portion 21 for the rolling contact bearing 8 and the venting channel 5 are shown in bold continuous lines.

FIG. 8 shows the transmission housing 9 according to sectional line VIII-VIII of FIG. 7. The axial offset V between the central plane E1 comprising the axis of rotation A and the longitudinal axis B of the venting channel are particularly obvious. The longitudinal axis B and the central plane E2 of the opening 6 are offset in the preferential direction of rotation R in such a way that, when the rolling contact bearing 8 rotates in the preferential direction of rotation, the rolling contact members 19 comprise a downward movement component, i.e. away from the opening 6. As already mentioned above, this embodiment achieves a particularly good pumping effect for conveying lubricant from the venting channel 5 into the interior 3 of the housing 9.

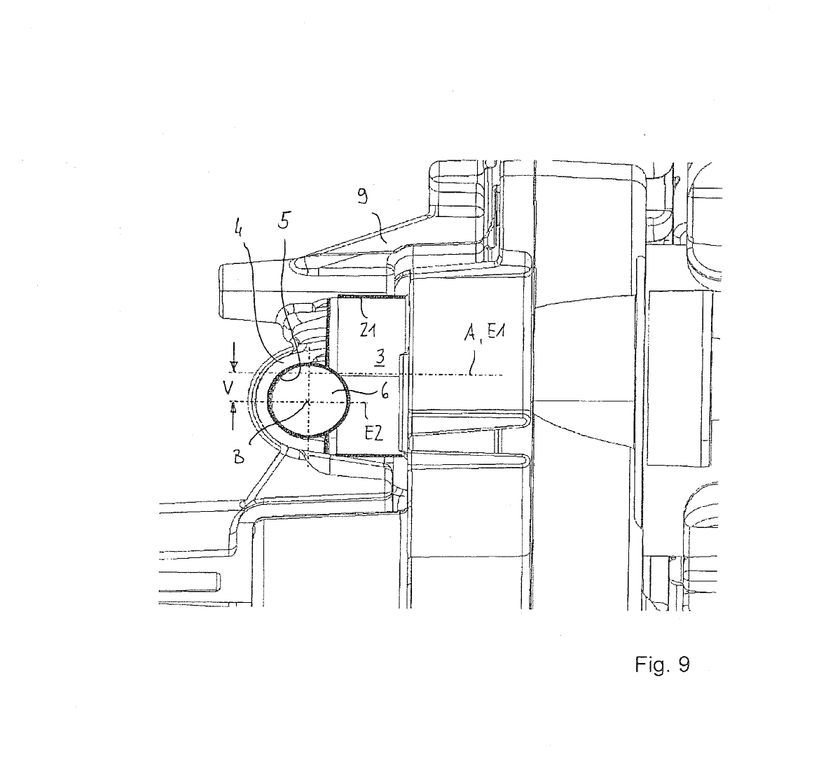

FIG. 9 shows the transmission housing 9 in a horizontal section, at least partially through the region of the opening 6, if viewed from below. It is possible to see the axis of rotation A of the shaft and of the rolling contact bearing 8 respectively, as well as the offset V between the plane E1 and a parallel plane E2 through the longitudinal axis B. Furthermore, the cylindrical portion of the venting channel 5 as well as the cylindrical portion for supporting the rolling contact bearing 8 in the interior 3 can be seen; they are emphasised by a bold line. The cylindrical chamber of the venting channel 5 and the cylindrical chamber of the interior 3 form an overlap which forms the opening 6 through which, under operational conditions, lubricant can flow from the venting channel 5 into the interior 3 of the housing 9. As a result of the axial offset V of the opening 6 relative to the axis of rotation A there is achieved a particularly high pumping effect.

Overall, the exemplary venting assemblies 2 according to embodiments shown in FIGS. 1, 2 and 6 to 9 and according to FIGS. 3 to 5 are advantageous in that the rolling contact bearing 8, which serves to support the shaft 7, can be used to generate a pumping effect from the venting channel 5 towards the interior 3 of the transmission housing. In this way—when the transmission is in operation and more particularly at high rotational speeds—lubricant is prevented from escaping from the interior 3 into the environment.

The exemplary venting assemblies 2 are suitable for units in which rotating components run in lubricating agents and are supported by rolling contact bearings relative to a stationary component so as to rotate around an axis of rotation. In the case of such units, foam can occur especially at high rotational speeds, preferred applications being transmissions whose shafts and gears rotate at particularly high speeds, an example being a hybrid transmission for driving an axle of a motor vehicle, wherein the hybrid transmission is driven by an electric motor and can also contain a subsequent differential gear. A further application for an exemplary venting assembly 2 is a manual transmission in the driveline of a motor vehicle or a turbo drive. It is of course also conceivable for the exemplary venting assembly to be used in industrial drives which contain rolling contact bearings for supporting rotating components.

What is claimed is:

1. A venting assembly for a unit with components running in a lubricant, comprising:
a housing part;
a rotating component which, by a rolling contact bearing, is rotatably supported around an axis of rotation (A) relative to the housing part; and
a venting channel for venting the unit, wherein an inner opening of the venting channel is arranged so as to axially adjoin the rolling contact bearing and wherein, in an axial view, the opening of the venting channel at least partially overlaps the rolling contact bearing;
wherein the rolling contact bearing comprises a vertical first central plane (E1) comprising the axis of rotation (A) and wherein the inner opening comprises a vertical second central plane (E2), wherein the vertical second central plane (E2) is arranged so as to be offset relative to the vertical first central plane (E1).

2-18. (canceled)

19. A venting assembly according to claim 1, wherein the venting channel forms a venting chamber and that, in the region of the rolling contact bearing, the unit forms a bearing chamber, wherein the venting chamber and the bearing chamber overlap, so that a through-aperture is formed.

20. A venting assembly according to claim 1, wherein, between an end face of the rotating component and a wall portion of the housing part, a gap is formed, wherein the width of the gap is smaller than the smallest diameter of the venting channel in the region of the opening.

21. A venting assembly according to claim 1, wherein the venting channel forms a venting chamber and wherein, in the region of the rolling contact bearing, the unit forms a bearing chamber, wherein an intermediate wall is arranged between the venting chamber and the bearing chamber, wherein the intermediate wall comprises a through-aperture.

22. A venting assembly according to claim 4, wherein, between the rolling contact bearing and the intermediate wall, there is formed a gap, wherein an axial width (B1) of the gap is smaller than a radial extension of the rolling contact bearing.

23. A venting assembly according to claim 4, wherein the through-aperture conically widens from the venting channel towards the rolling contact bearing.

24. A venting assembly according to claim 4, wherein the through-aperture, in a transition portion towards an interior, comprises an extension component in a circumferential direction.

25. A venting assembly according to claim 1, wherein the inner opening of the venting channel is at least partially arranged between a greatest outer diameter (D1) of the rolling contact bearing and a smallest inner diameter of the rolling contact bearing.

26. A venting assembly according to claim 1, wherein the inner opening of the venting channel, in its entirety, is arranged in a region between a greatest outer diameter of the rolling contact bearing and a smallest inner diameter of the rolling contact bearing.

27. A venting assembly according to claim 1, wherein, in an axial view of the rolling contact bearing, the inner opening of the venting channel is at least partially arranged in a region in which the rolling contact members of the rolling contact bearing comprise a vertically downwards directed movement component in a preferential direction of rotation (R) of the rolling contact bearing.

28. A venting assembly according to claim 1, wherein the housing part, which forms the venting channel, is at least partially formed onto a housing of the unit, so as to be integral with the housing.

29. A venting assembly according to claim 1, wherein the venting channel is set back towards an outside relative to a wall portion of the housing part, which wall portion is arranged vis-à-vis an end face of the rotating component.

30. A venting assembly according to claim 1, wherein a plug device is provided which closes an outer opening of the venting channel, wherein the plug device comprises a labyrinth seal through which air can flow.

31. A venting assembly according to claim 13, wherein the plug device comprises an insertable part with a base, which insertable part is positioned at least partially in the venting channel, wherein the insertable part comprises at least one lateral aperture to allow the passage of air.

32. A venting assembly according to claim 14, wherein the plug device comprises a removable cap which is releasably connectable to the insertable part by means of a snap-in connection.

33. A transmission assembly comprising a transmission housing which forms an interior chamber and in which at least two driveshafts for transmitting torque are drivingly connected to one another, further comprising a venting assembly according to claim 1, wherein the housing part of the venting assembly forms part of the transmission housing, wherein the rotating component is one of the at least two driveshafts and wherein the venting channel serves to vent the interior chamber.

34. A transmission assembly according to claim 16, wherein the transmission assembly is a multi-step transmission for a hybrid drive.
